(19) United States
(12) Patent Application Publication
(10) Pub. No.: US 2004/0037227 A1
(43) Pub. Date: Feb. 26, 2004

(54) Circuit for enhancing scan testing capability of a digital IC tester

(76) Inventors: Kuo-Hung Shih, Miaoli (TW); Shao-Ming Wei, Hsinchu (TW); Hung-Hsing Kuo, Kaohsiung (TW); Ming-Hung Hsu, Taipei (TW); Huang-Hui Liu, Hsinchu (TW); Che-Pin Su, Chiai (TW)

Correspondence Address: RABIN & Berdo, PC, 1101 14TH STREET, NW, SUITE 500, WASHINGTON, DC, 20005, US

(21) Appl. No.: 10/223,483

(22) Filed: Aug. 20, 2002

(51) Int. Cl. H04L 1/00

(52) U.S. Cl. 370/241

(57) ABSTRACT

A circuit for enhancing scan testing capability of a digital IC tester. The circuit is connected between the digital IC tester and a DUT. The circuit comprises a binary counter receiving a clock signal from the digital IC tester to sequentially output addresses, a memory device storing scan-in and expected scan-out data, and receiving the addresses from the binary counter to output the scan-in data to a scan chain and the expected scan-out data corresponding to the addresses, a delay circuit receiving the clock signal from the digital IC tester and outputting the delayed clock signal to the scan chain, and a comparator receiving scan-out data from the scan chain and the expected scan-out data from the memory device, and outputting comparison results to the digital IC tester

### BACKGROUND OF THE INVENTION

1. Field of the Invention

The present invention relates to digital IC scan testing and particularly to a circuit for enhancing the scan testing capability of a digital IC tester.

2. Description of the Prior Art

FIG. 1 is a diagram showing a conventional circuit configuration for digital IC scan testing. A device under test (DUT) 12 is connected to a digital IC tester, such as such as one available from Schlumberger, MegaTest or others. The DUT 12 comprises a combinational logic circuit 121 and a scan chain 122. The combinational logic circuit 121 receives primary input data PIs from the digital IC tester 11 and outputs primary output data POs back to the digital IC tester 11. The combinational logic circuit 121 also generates intermediate data inter_out_{—}1˜inter_out_n to the scan chain 122. The scan chain 122 has 10, 100, 1000 or even more flip-flops 1221 connected in series, each of which is accompanied by a multiplexer 1222. The multiplexer 1222 accompanying the first flip-flops 1221 in the scan chain 122 receives scan-in data from the digital IC tester 11 and the others receive the output data from a previous flip-flop 1221. Each multiplexer 1222 also receives an intermediate output data inter_out_{—}1˜inter_out_n and selectively outputs scan-in data or the output data of the previous flip-flop 1221, and the intermediate output data to the next flip-flop 1221 according to a scan-enable signal EN received from the digital IC tester 11. The flip-flops 1221 forward the received data to the combinational logic circuit 121 (initial_{—}1˜initial_n) or the multiplexer 1222 accompanying the next flip-flop by the clock signal from the digital IC tester 11. The scan-out data output from the last flip-flop 1221 in the scan chain is sent back to the digital IC tester 11. The digital IC tester pre-stores the expected scan-out pattern and primary output data and compares them with the data received from the DUT 12 to identify any failures in the DUT 12.

FIG. 3 is a diagram showing the timing of the data transmission and signals of the circuit shown in FIG. 1.

In a phase P1, the clock signal is active and composed of n clocks, wherein n is the number of the flip-flops 1221 in the scan chain 122. The scan-enable signal EN is active and has a high logic level, whereby the multiplexers 1222 select the scan-in data from the digital IC tester 11 or the data from the previous flip-flop 1221 as the data output to their accompanied flip-flops 1221. As the scan-in data is output by the digital IC tester 11 from the terminal Out_{—}2 and forwarded through the flip-flops 1221 upon the rising edges of the clock signal, each of the flip-flops 1221 has an assigned initial value stored. The scan-out data pushed out from the last flip-flop 1221 as the scan-in data is forwarded through the flip-flops 1221 is composed of random values initially existing in the flip-flops 1221. The primary input data PIs is not transmitted from the terminal Out_{—}1 of the digital IC tester 11 and there is no primary output data received from the terminal In_{—}1. Accordingly, the comparison of the output data from the DUT 12 is ignored.

In next phase P2, the primary input data PIs and the initial data initial_{—}1˜initial_n stored into the flip-flops 1221 in phase P1 are input to the combinational logic circuit 121. In response to the input data, the intermediate output data inter_out_{—}1˜inter_out_n is generated by the combinational logic circuit 121. The clock signal is active and composed of 1 clock. The scan-enable signal EN starts to be inactive before the rising edge of the clock and has a low logic level, whereby the multiplexers 1222 select the intermediate output data inter_out_{—}1˜inter_out_n from the combinational logic circuit 121 as the data output to their accompanied flip-flops 1221. Upon the rising edge of the clock, the intermediate output data inert_out_{—}1˜inter_out_n is stored into the flip-flops 1221. The scan-in data from the digital IC tester 11 and the intermediate output data inert_out_{—}1˜inter_out_n stored in the flip-flops 1221 are output but held at the multiplexers 1222 since the scan-enable signal EN is inactive. The scan-out data pushed out from the last flip-flop 1221 upon the rising edge of the clock is output to the digital IC tester 11 and is compared to the pre-stored expected scan-out pattern.

In a phase P3, the clock signal is inactive while the scan-enable signal EN is active, whereby the data held at the multiplexers 1222 in phase P2 is transmitted to and is held at the input of the flip-flops 1221. The scan-out data is kept the same as that in phase P2. The primary output data POs is output to the digital IC tester and is compared to the pre-stored expected primary output data.

In the next phase, phase P1 is repeated. Now, the scan-out data pushed out from the last flip-flop 1221 as the scan-in data is forwarded through the flip-flops 1221 does not contain random values, but rather the intermediate output data inter_out_{—}1˜inter_out_n generated previously. The comparison of the scan-out data from the DUT 12 is implemented by the digital IC tester 11.

FIG. 2 is a diagram showing another conventional circuit configuration for digital IC scan testing. This is similar to that shown in FIG. 1 except that the scan chain 122 is replaced by a multiple scan chain 222. The multiple scan chain 222 is composed of several scan chains connected in parallel. The scan-in and scan-out data are parallel bits transmitted to and from the multiple scan chain 222.

However, low cost digital IC testers are not suitable for the previously described conventional test configuration since they usually do not have scan testing ability. Using parallel patterning instead of scan patterning may solve the problem but the parallel pattern memory depth of the low cost digital IC tester is limited to only 2˜4 mega bytes. ICs embedded with scan testing functions may also perform a scan test with the low cost digital IC tester but this will degrade the IC performance and increase circuit area.

### SUMMARY OF THE INVENTION

The object of the present invention is to provide a circuit for enhancing scan testing capability of a low cost digital IC tester.

The present invention provides a circuit for enhancing scan testing capability of a digital IC tester. The circuit is connected between the digital IC tester, and a DUT having a combinational logic circuit and scan chain, wherein the combinational logic circuit receives and outputs primary input and output data from and to the digital IC tester respectively, and the scan chain receives a scan-enable signal from the digital IC tester. The circuit comprises a binary counter receiving a clock signal from the digital IC tester to sequentially output addresses, a memory device storing scan-in and expected scan-out data, and receiving the addresses from the binary counter to output the scan-in data to the scan chain and the expected scan-out data corresponding to the addresses, a delay circuit receiving the clock signal from the digital IC tester and outputting the delayed clock signal to the scan chain, and a comparator receiving scan-out data from the scan chain and the expected scan-out data from the memory device, and outputting comparison results to the digital IC tester.

The present invention further provides an apparatus for digital IC scan testing. The apparatus comprises a digital IC tester, a DUT having a combinational logic circuit and scan chain, wherein the combinational logic circuit receives and outputs primary input and output data from and to the digital IC tester respectively, and the scan chain receives a scan-enable signal from the digital IC tester, a binary counter receiving a clock signal from the digital IC tester to sequentially output addresses, a memory device storing scan-in and expected scan-out data, and receiving the addresses from the binary counter to output the scan-in data to the scan chain and the expected scan-out data corresponding to the addresses, a delay circuit receiving the clock signal from the digital IC tester and outputting the delayed clock signal to the scan chain, and a comparator receiving scan-out data from the scan chain and the expected scan-out data from the memory device, and outputting comparison results to the digital IC tester.

### BRIEF DESCRIPTION OF THE DRAWINGS

The present invention will become more fully understood from the detailed description given hereinbelow and the accompanying drawings, given by way of illustration only and thus not intended to be limitative of the present invention.

FIG. 1 is a diagram showing a conventional circuit configuration for digital IC scan testing.

FIG. 2 is a diagram showing another conventional circuit configuration for digital IC scan testing.

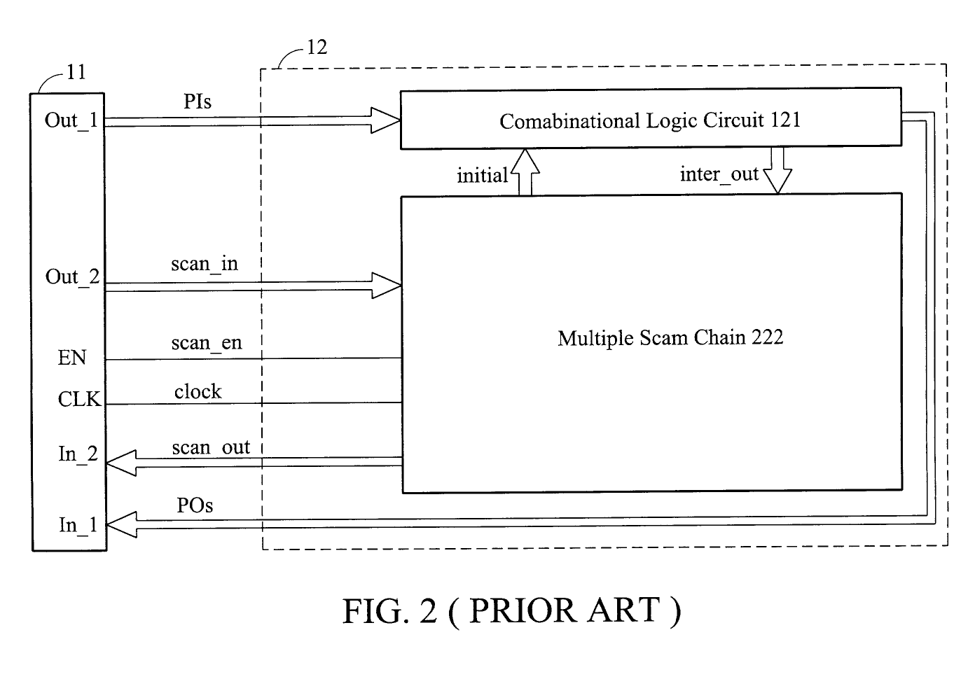

FIG. 3 is a diagram showing the timing of the data transmission and signals of the circuit shown in FIG. 1.

FIG. 4 is a diagram showing a circuit configuration for digital IC scan testing according to one embodiment of the invention.

FIG. 5 is a diagram showing a circuit configuration for digital IC scan testing according to another embodiment of the invention.

FIG. 6 is a diagram showing the timing of the data transmission and signals of the circuit shown in FIG. 3.

### DETAILED DESCRIPTION OF THE INVENTION

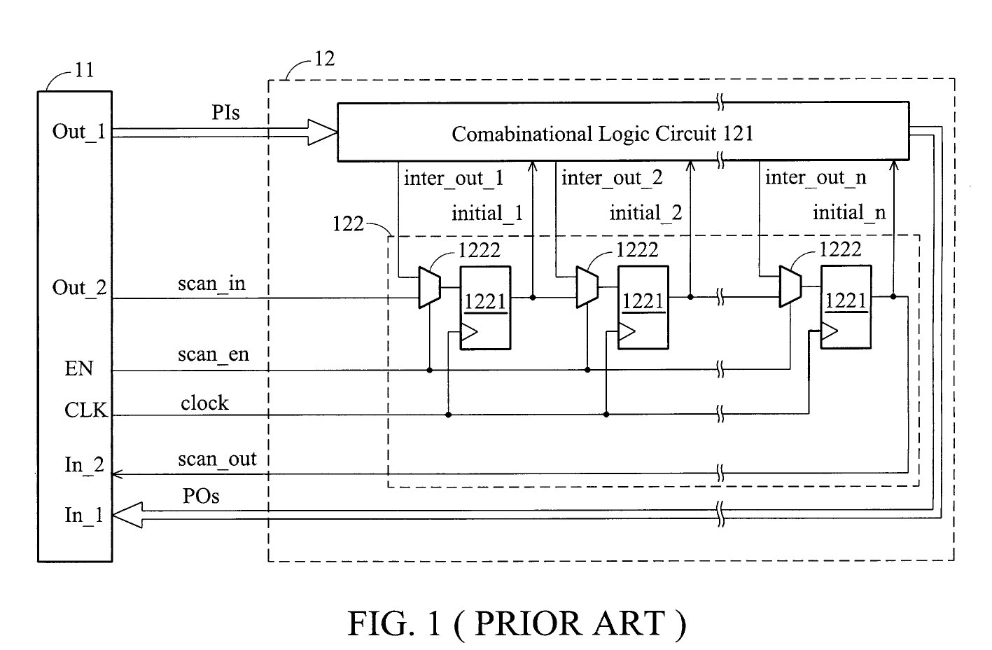

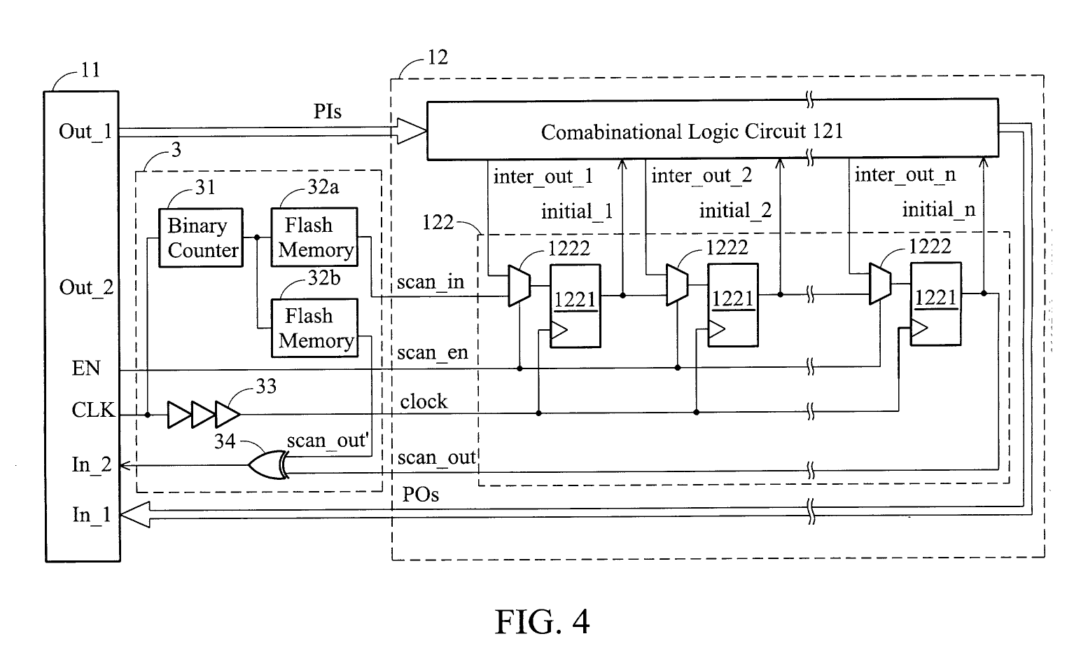

FIG. 4 is a diagram showing a circuit configuration for digital IC scan testing according to one embodiment of the invention. The same elements in FIGS. 1 and 4 refer to the same symbol for clarity. An enhancing circuit 3 is connected between the digital IC tester 11, and a DUT 12 having a combinational logic circuit 121 and scan chain 122, wherein the combinational logic circuit 121 receives and outputs primary input data PIs and primary output data POs from and to the digital IC tester 11 respectively, and the scan chain 122 receives a scan-enable signal EN from the digital IC tester 11. The enhancing circuit 3 comprises a binary counter 31, flash memories 32a and 32b, a delay circuit 33, and an XOR gate 34. The binary counter 31 receives the clock signal from the digital IC tester 11 to sequentially output addresses of scan-in data and expected scan-out pattern in the flash memories 32a and 32b. The flash memories 32a and 32b respectively store scan-in and expected scan-out data, and receive the addresses from the binary counter 31 to correspondingly output the scan-in data to the scan chain 122 and the expected scan-out data scan_out′ to the XOR gate 34. The delay circuit 33 receives the clock signal from the digital IC tester 11 and outputs the delayed clock signal to the scan chain 122. The XOR gate receives the scan-out data from the scan chain 122 and the expected scan-out data from the flash memory 32b, and outputs comparison results to the digital IC tester 11.

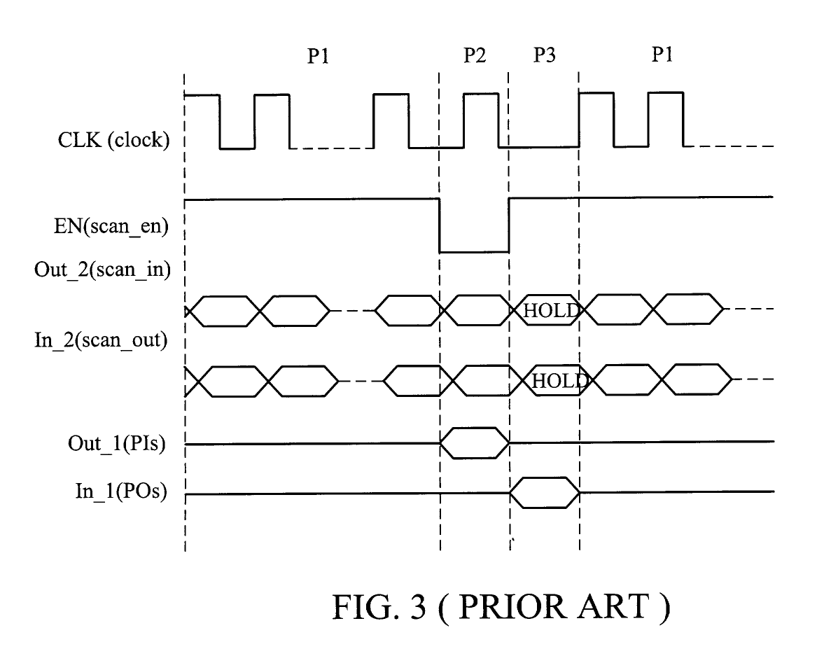

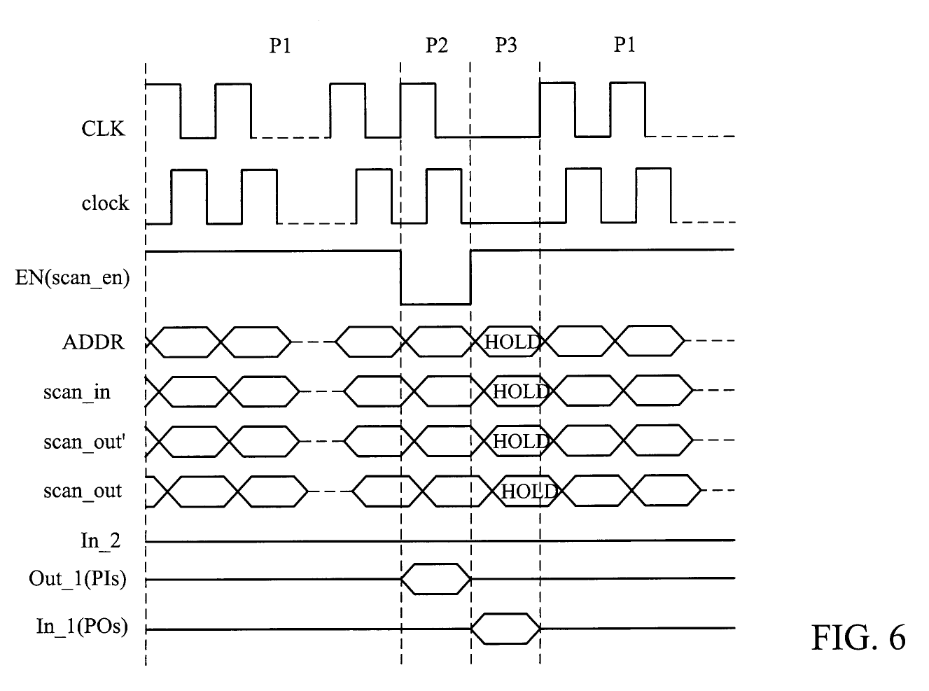

FIG. 6 is a diagram showing the timing of the data transmission and signals of the circuit shown in FIG. 3.

In phase P1, the clock signal CLK output from the digital IC tester 11 is active and composed of n clocks, wherein n is the number of the flip-flops 1221 in the scan chain 122. The scan-in data is stored in the flash memory 32a but not in the digital IC tester 11. Upon the rising edges of the n clocks, the binary counter 31 outputs the addresses to the flash memories 32a and 32b. The terminal Out_{—}2 of the digital IC tester 11 for scan-in data output is not connected. The delayed clock signal is sent to the flip-flops 1221 in the scan chain 122, and the scan-enable signal EN is active and has a high logic level, whereby the multiplexers 1222 select the scan-in data from the flash memory 32a or the data from the previous flip-flop 1221 as the data output to their accompanied flip-flops 1221. As the scan-in data is output by the flash memory 32a corresponding to the addresses output from the binary counter 31 and forwarded through the flip-flops 1221 upon the rising edges of the delayed clock signal, each of the flip-flops 1221 has an assigned initial value stored. The scan-out data scan_out pushed out from the last flip-flop 1221 as the scan-in data is forwarded through the flip-flops 1221 is composed of random values initially existing in the flip-flops 1221. The primary input data PIs is not transmitted from the terminal Out_{—}1 of the digital IC tester 11 and there is no primary output data received from the terminal In_{—}1. Accordingly, the comparison results of the scan-out data generated by the XOR gate 34 and input to the terminal In_{—}2 of the digital IC tester 11, and those of the primary output data derived by the digital IC tester 11 are ignored.

In the next phase P2, the primary input data PIs and the initial data initial_{—}1˜initial n stored into the flip-flops 1221 in phase P1 are input to the combinational logic circuit 121. In response to the input data, the intermediate output data inter_out_{—}1˜inter_out_n are generated by the combinational logic circuit 121. The clock signal CLK is active and composed of 1 clock. The scan-enable signal EN starts to be inactive before the rising edge of the delayed clock signal and has a low logic level, whereby the multiplexers 1222 select the intermediate output data inter_out_{—}1˜inter out n from the combinational logic circuit 121 as the data output to their accompanied flip-flops 1221. Upon the rising edge of the clock in the delayed clock signal, the intermediate output data inert_out_{—}1˜inter_out_n is stored into the flip-flops 1221. The scan-in data from the flash memory 32a and the intermediate output data inert_out_{—}1˜inter_out_n stored in the flip-flops 1221 is output but held at the multiplexers 1222 since the scan-enable signal EN is inactive. The scan-out data pushed out from the last flip-flop 1221 upon the rising edge of the clock in the delayed clock signal is output to the XOR gate 34 and is compared to the expected scan-out pattern scan_out′ pre-stored in and output from the flash memory 32b.

In phase P3, the clock signal CLK is inactive while the scan-enable signal EN is active, whereby the delayed clock signal is also inactive, the address output from the binary counter 31 is held as well as the data scan_in and scan_out′, and the data held at the multiplexers 1222 in phase P2 are transmitted to and is held at the input of the flip-flops 1221. The data scan_out is kept the same as that in phase P2. The primary output data POs is output to the digital IC tester 11 and is compared to the pre-stored expected primary output data.

In the next phase, phase P1 is repeated. Now, the scan-out data pushed out from the last flip-flop 1221 as the scan-in data is forwarded through the flip-flops 1221 are not random values but the intermediate output data inter_out_{—}1˜inter_out_n generated previously. The comparison results of the data scan_out and scan_out′ are generated by the XOR gate 34 and input to the terminal In_{—}2 of the digital IC tester 11, which are normally low logic levels otherwise a failure in the DUT 12 is identified.

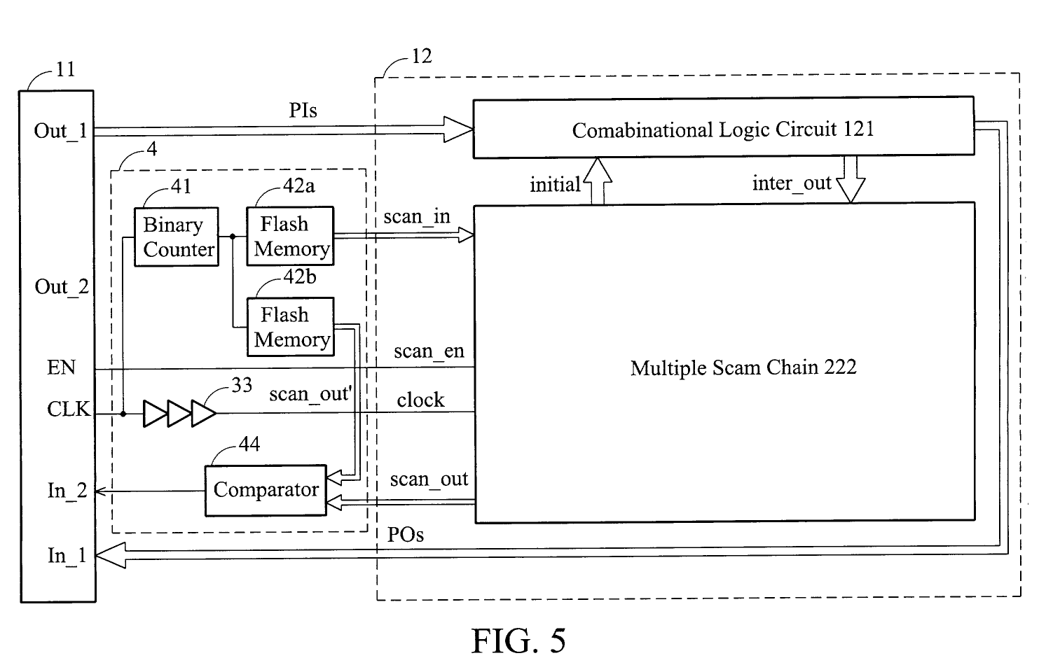

FIG. 5 is a diagram showing a circuit configuration for digital IC scan testing according to another embodiment of the invention. This is similar to that shown in FIG. 3 except that the scan chain 122, the XOR gate 34, and the flash memories 32a and 32b are replaced by the multiple scan chain 222, a parallel comparator 44, and flash memories 42a and 42b. The multiple scan chain 222 is composed of several scan chains connected in parallel. The data scan_in, scan_out, scan_out′ and comparison results are bits transmitted in parallel.

The following table shows the data stored in the digital IC tester 11 according to the previous described embodiment of the invention. It is noted that, in each phase P1, the data is repeated n times, and may be stored one time and transmitted n times since the data output from the terminal Out_{—}2 for scan-in is unused and the expected scan-out data for comparison is always at low logic levels since the digital IC tester 11 only needs to identify if there is a high logic level in the comparison results from the XOR gate or comparator. This reduces the memory usage of the digital IC tester and enhances the scan testing capability of the low cost digital IC tester.

| | | | | Expected | | Expected |
|---|---|---|---|---|---|---|
| Phase | EN | CLK | Scan-in | scan-out | PIs | POs |
| P1 | 1 | 1 | Unused | Ignored | Ignored | Ignored |
| | 1 | 1 | Unused | Ignored | Ignored | Ignored |
| | 1 | 1 | Unused | Ignored | Ignored | Ignored |
| | . | . | . | . | . | . |
| | . | . | . | . | . | . |
| | . | . | . | . | . | . |
| | 1 | 1 | Unused | Ignored | Ignored | Ignored |
| P2 | 0 | 1 | Unused | 0 | Data | Ignored |
| P3 | 1 | 0 | Unused | 0 | Ignored | Data |
| P1 | 1 | 1 | Unused | 0 | Ignored | Ignored |
| | 1 | 1 | Unused | 0 | Ignored | Ignored |
| . | . | . | . | . | . | . |
| . | . | . | . | . | . | . |
| . | . | . | . | . | . | . |
| | 1 | 1 | Unused | 0 | Ignored | Ignored |
| . | . | . | . | . | . | . |
| . | . | . | . | . | . | . |
| . | . | . | . | . | . | . |

The foregoing description of the preferred embodiments of this invention has been presented for purposes of illustration and description. Obvious modifications or variations are possible in light of the above teaching. The embodiments were chosen and described to provide the best illustration of the principles of this invention and its practical application to thereby enable those skilled in the are to utilize the invention in various embodiments and with various modifications as are suited to the particular use contemplated. All such modifications and variations are within the scope of the present invention as determined by the appended claims when interpreted in accordance with the breadth to which they are fairly, legally, and equitably entitled.

What is claimed is:

1. A circuit for enhancing scan testing capability of a digital IC tester, the circuit connected between the digital IC tester and a DUT having a combinational logic circuit and scan chain, wherein the combinational logic circuit receives and outputs primary input and output data from and to the digital IC tester respectively, and the scan chain receives a scan-enable signal from the digital IC tester, the circuit comprising:
a binary counter receiving a clock signal from the digital IC tester to sequentially output addresses;
a memory device storing scan-in and expected scan-out data, and receiving the addresses from the binary counter to output the scan-in data to the scan chain and the expected scan-out data corresponding to the addresses;
a delay circuit receiving the clock signal from the digital IC tester and outputting the delayed clock signal to the scan chain; and
a comparator receiving scan-out data from the scan chain and the expected scan-out data from the memory device, and outputting comparison results to the digital IC tester.

2. The circuit as claimed in claim 1, wherein the scan chain is a multiple scan chain.

3. The circuit as claimed in claim 2, wherein the comparator comprises a plurality of XOR gates connected in parallel.

4. The circuit as claimed in claim 1, wherein the scan chain comprises:
a plurality of flip-flops connected in series, receiving the delayed clock signal from the delay circuit and outputting initial data to the combinational logic circuit; and
a plurality of multiplexers corresponding to the flip-flops receiving intermediate output data from the combinational logic circuit and the scan-in data, and receiving the scan-enable signal to selectively output one of the intermediate output data and the scan-in data.

5. The circuit as claimed in claim 4, wherein the comparator is an XOR gate.

6. The circuit as claimed in claim 1, wherein the memory device is a flash memory.

7. An apparatus for digital IC scan testing comprising:
a digital IC tester;
a DUT having a combinational logic circuit and scan chain, wherein the combinational logic circuit receives and outputs primary input and output data from and to the digital IC tester respectively, and the scan chain receives a scan-enable signal from the digital IC tester;
a binary counter receiving a clock signal from the digital IC tester to sequentially output addresses;
a memory device storing scan-in and expected scan-out data, and receiving the addresses from the binary counter to output the scan-in data to the scan chain and the expected scan-out data corresponding to the addresses;
a delay circuit receiving the clock signal from the digital IC tester and outputting the delayed clock signal to the scan chain; and
a comparator receiving scan-out data from the scan chain and the expected scan-out data from the memory device, and outputting comparison results to the digital IC tester.

8. The circuit as claimed in claim 7, wherein the scan chain is a multiple scan chain.

9. The circuit as claimed in claim 8, wherein the comparator comprises a plurality of XOR gates connected in parallel.

10. The circuit as claimed in claim 7, wherein the scan chain comprises:
a plurality of flip-flops connected in series, receiving the delayed clock signal from the delay circuit and outputting initial data to the combinational logic circuit; and
a plurality of multiplexers corresponding to the flip-flops receiving intermediate output data from the combinational logic circuit and the scan-in data, and receiving the scan-enable signal to selectively output one of the intermediate output data and the scan-in data.

11. The circuit as claimed in claim 10, wherein the comparator is a XOR gate.

12. The circuit as claimed in claim 7, wherein the memory device is a flash memory.
